(19) United States
(12) Patent Application Publication
(10) Pub. No.: US 2009/0045709 A1
(43) Pub. Date: Feb. 19, 2009

(54) Cabinet with retractable sliding door and assembly procedure thereof

(75) Inventors: Rafael Moral Lucas, Madrid (ES); Manuel Moreno Garcia, Madrid (ES); Jose Maria Hernandez Gonzalez, Madrid (ES); Teodosio Manzano Macia, Madrid (ES)

Correspondence Address: BANNER & WITCOFF, LTD., 1100 13th STREET, N.W., SUITE 1200, WASHINGTON, DC, 20005-4051, US

(73) Assignee: AF STEELCASE, S.A., Madrid (ES)

(21) Appl. No.: 11/919,740

(22) PCT Filed: Feb. 10, 2006
(86) PCT No.: PCT/ES2006/070012

§ 371 Date: Nov. 1, 2007

(51) Int. Cl. E06B 7/34

(52) U.S. Cl. 312/323

(57) ABSTRACT

The present invention relates to a cabinet with retractable sliding doors, from among those having doors similar to blinds that are housed between two lateral sandwich panels. The preferred application of this invention is in metallic cabinets used as office furniture. The disclosed cabinet is characterised by having a right-hand side assembly and a left-hand side assembly consisting of two lateral sandwich panels with upper and lower end pieces that house the retractable doors, the cabinet also being provided with a lower horizontal panel and an upper horizontal panel with guides for opening and closing the doors and a back panel that closes the cabinet. The cabinet disclosed in assembled by the following stages:
Pre-assembling the left-hand side and right-hand side lateral assemblies consisting of the union of the lateral sandwich panels to the upper and lower end pieces, mounting the retractable doors in them;
Joining the right-hand side and left-hand side lateral assemblies to the upper and lower panels;
Joining to the back panel.

### OBJECT OF THE INVENTION

The present invention relates to a cabinet with retractable sliding doors, among those having doors similar to blinds that are housed in two lateral sandwich panels. The preferred application of this invention is in metallic cabinets used as office furniture.

The disclosed cabinet is characterised by having a right-hand side assembly and a left-hand side assembly consisting of two lateral sandwich panels with upper and lower end pieces that house the retractable doors, the cabinet also being provided with a lower horizontal panel and an upper horizontal panel with guides for opening and closing the doors and a back panel that closes the cabinet.

The cabinet assembly procedure comprises the following stages:
Pre-assembling the left-hand side and right-hand side lateral assemblies consisting of the union of the lateral sandwich panels to the upper and lower end pieces, mounting the retractable doors in them;
Joining the right-hand side and left-hand side lateral assemblies to the upper and lower panels;
Joining to the back panel.

### BACKGROUND OF THE INVENTION

Cabinets with retractable sliding doors are known in the prior art. These cabinets normally have an upper guide and a lower guide in which move the sliding doors that are concealed in its sides.

Normally, these guide pieces are integrated or united to the lower and upper horizontal panels of the cabinet. The cabinets are supplied disassembled and they are assembled in their final location.

They normally comprise at least the following elements:
A lower horizontal panel and an upper horizontal panel, which incorporate the guides in which the doors slide when they are opened and closed;
Four lateral panels, as the doors are concealed between two sandwich panels;
A back panel:
Blinds-like doors; and
Auxiliary parts.

This configuration has a first disadvantage in the difficulty of assembling it in its final location, particularly as regards installing the cabinet doors, which requires a considerable assembly time.

A further disadvantage of the configuration described is the large number of parts comprising this type of cabinet, which complicates its assembly and increases the time required for this task.

These drawbacks could be solved by a preliminary assembly of some of its parts, such as the doors as this is the part of the assembly requiring the greatest time. However, the volume occupied by the above-described parts would be large, thereby hindering its transport.

The cabinet taught by this invention solves the aforementioned drawbacks by using end pieces with a guide to house the doors, the configuration of which allows an in-factory pre-assembly of the two lateral panels and the retractable door.

This allows reducing the number of final parts to be assembled at the final location of the cabinet, which will be reduced to two sets formed by the retractable doors, the lateral panels and the lateral parts; and a lower horizontal panel, an upper horizontal panel and a back panel.

Transporting the sets formed by the pre-assembled lateral panels and the door presents no difficulty, as its surface area is the same as that occupied by one lateral panel and its thickness is that of the space required between the two panels to house the retractable door.

The main advantage of this in-factory pre-assembly is a significant reduction in the time and cost of assembling the cabinet at its final location.

Finally, a further advantage provided by the configuration taught in this invention is to allow a rigid union of all the cabinet elements, which will be anchored to the guide piece placed between the lateral sandwich panels by quick connection means.

### DESCRIPTION OF THE INVENTION

The present invention relates to a cabinet, among those having retractable sliding doors that are housed between two lateral sandwich panels.

The cabinet taught is characterised by comprising a right-hand side assembly and a left-hand side assembly consisting of two lateral sandwich panels with upper and lower end pieces that house the retractable doors, the cabinet also comprising a lower horizontal panel and an upper horizontal panel provided with guides for opening and closing the doors and a back panel that closes the cabinet.

The end pieces are thus placed between the lateral sandwich panels, forming an assembly that contains the sliding doors inside it. This configuration has two clear advantages. Firstly, it allows an in-factory pre-assembly of the sliding door; secondly, it simplifies the transportation of the element thus obtained as its surface is not greater than that of one lateral panel, and its thickness is similar to that of the end pieces.

The end pieces have a guide to house the retractable doors and allow them to slide; these doors are placed after a guide on which the doors slide when they are closed and opened, integrated in the lower and upper horizontal panels of the cabinet, so that when the doors are opened they slide in the guide of the lower and upper horizontal panels and are retracted in the end pieces placed on the sides of the cabinet.

The end pieces comprise at least the following elements: a guide to house the doors; end brackets for attachment to the lateral, back and lower and upper horizontal panels; and longitudinal notches in which the lateral panels are introduced, which are then attached to the lateral piece by screws.

The guide of the end pieces has a first segment placed in line with the guides of the lower or upper horizontal panels of the cabinet, followed by an elbow of approximately 90° and then an oblique segment followed by a first segment parallel to the cabinet sides, and finally a U-elbow followed by a second segment also parallel to the cabinet sides.

The guide of the end piece also has a central protrusion on its base and along its entire length for a correct displacement of the sliding door, which ends at an arrowhead by which it is inserted without discontinuity in the guide of the upper or lower horizontal panel.

The assembly procedure for the cabinet with retractable sliding doors is therefore characterised in that the special configuration of its component parts allows an in-factory pre-assembly of the sides that form a set including the sliding doors. This pre-assembled set can be easily transported to its final location as its dimensions allow this. Another important characteristic is that the attachment means for the various component elements of the cabinet are simple to connect and few in number, thereby reducing the time required to assemble the cabinet.

The assembly procedure comprises the following stages:
Pre-assembling the left-hand side and right-hand side lateral assemblies consisting of the union of the lateral sandwich panels to the upper and lower end pieces and mounting the retractable doors inside;
Joining the right-hand side and left-hand side lateral assemblies to the upper and lower panels;
Joining to the back panel.

The end pieces are provided with at least one guide for housing the doors, end brackets for attachment to the lateral panels, back panel, lower and upper horizontal panels and longitudinal notches in which the lateral panels are introduced, which are attached to the end piece by screws.

Therefore, the end pieces and the lateral panels are joined through the longitudinal notches in which said panels are inserted, attached by screws, subsequently inserting the retractable door, which slides in the guide of the end pieces and is housed between the lateral panels. This assembly is supplied pre-assembled in the factory, as its configuration and small size allow transporting it, thereby reducing the time required to assemble the cabinet at its final location with the ensuing savings in time and expense.

The right-hand side and left-hand side lateral assemblies and the upper and lower horizontal panels are joined through the orifices made in the horizontal segments of the brackets of the end piece.

The back panel is joined through orifices of the vertical segment of the bracket of the end piece.

### DESCRIPTION OF THE DRAWINGS

The present descriptive memory is completed by a set of drawings that illustrate the preferred embodiment of the invention without limiting it.

FIG. 1 is a perspective view of the component elements of the cabinet in the assembled position.

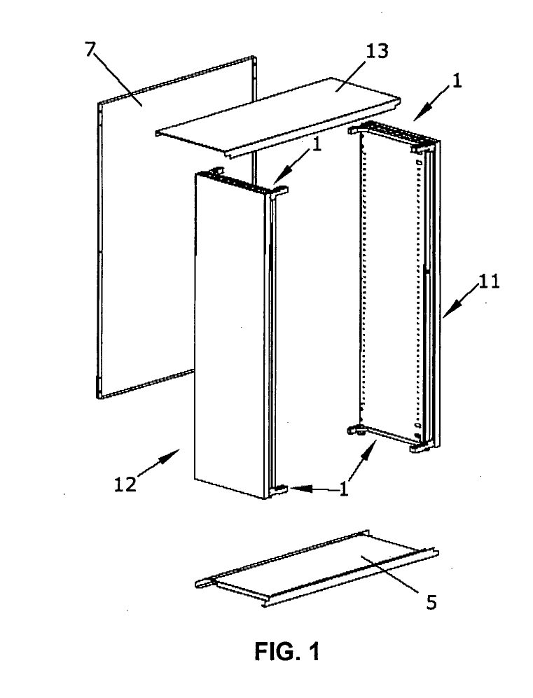

FIG. 2 is a perspective view of the lateral pieces that house the doors of the cabinet taught.

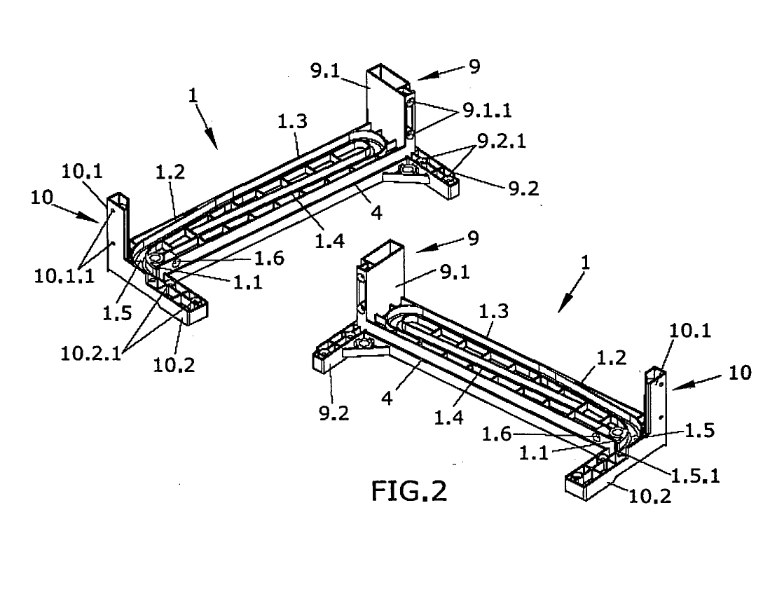

FIG. 3 is a perspective view of the assembly formed by a lateral piece and the lateral sandwich panels.

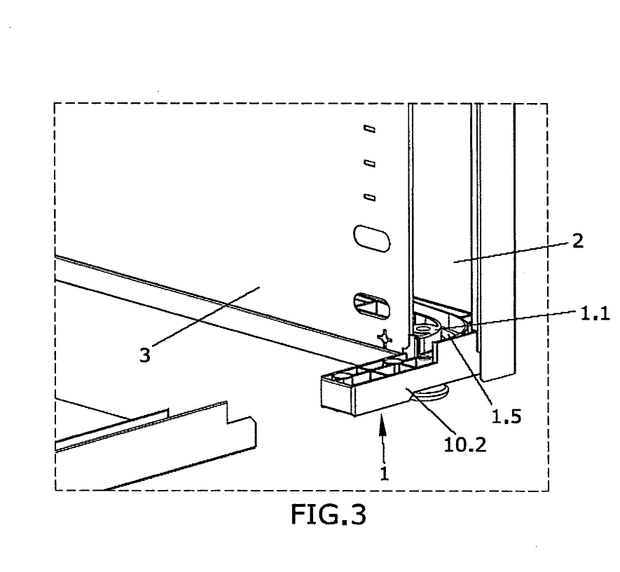

FIG. 4 is a perspective view of a corner of the assembled cabinet with the door in retracted position.

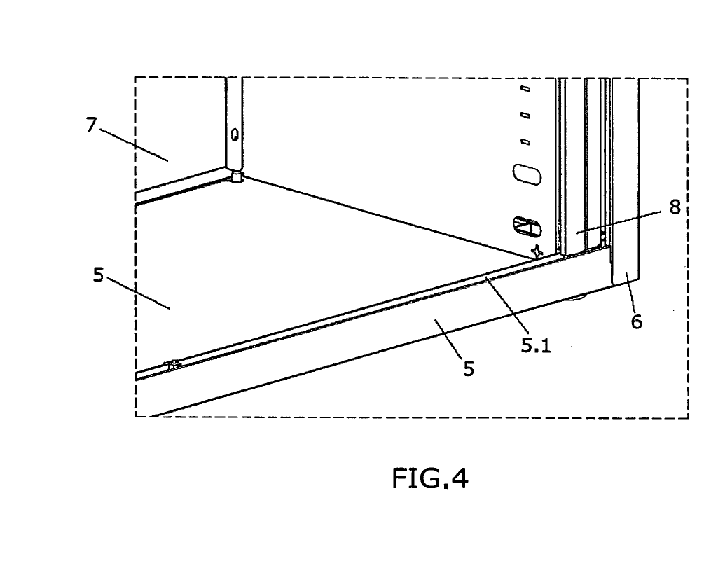

### PREFERRED EMBODIMENT OF THE INVENTION

The present invention relates to a cabinet with retractable sliding doors, among those which house the doors (8) between two lateral sandwich panels (2, 3) characterised in that it comprises a right-hand side assembly (11) and a left-hand side assembly (12) which consist of two lateral sandwich panels (2, 3) with upper and lower end pieces (1) that house the retractable doors (8), the cabinet also comprising a lower horizontal panel (5) and an upper horizontal panel (13) with guides (5.1) for opening and closing the doors (8) and a back panel (7) that closes the cabinet.

The end pieces (1) comprise at least the following elements: a guide to house the doors (8); end brackets (9, 10) for attachment to the lateral panels (2, 3), back panel (7) and lower (5) and upper (13) horizontal panels; and longitudinal notches (4) in which the lateral panels (2, 3) are introduced, which are then attached to the lateral piece (1) by screws.

The guide of the end pieces (1) has a first segment (1.1) placed in line with the guide (5.1) of the lower horizontal panel (5) or with the guide of the upper horizontal panel (13), followed by an elbow at approximately 90° and then an oblique segment (1.2) followed by a first segment (1.3) parallel to the cabinet sides (2, 3), and finally a U-elbow followed by a second segment (1.4) also parallel to the cabinet sides (2, 3).

The guide of the end piece (1) also has a central protrusion (1.5) on its base and along its entire length for a correct displacement of the sliding door (8), which ends at an arrowhead (1.5.1) by which it is inserted without discontinuity in the guide (5.1) of the lower horizontal panel (5) or upper horizontal panel (13).

The rear bracket (9) is provided on its vertical segment (9.1) with two orifices (9.1.1) for attachment to the front sandwich panel (3) and the back panel (7), and on its horizontal segment (9.2) with another two orifices (9.2.1) for attachment to the lower horizontal panels (5) or upper horizontal panels (13), while the front bracket (10) is provided on its vertical segment (10.1) with two orifices (10.1.1) for attachment to the rear sandwich panel (2) and on its horizontal segment (10.2) it is provided with another two orifices (10.2.1) for attachment to the lower horizontal panels (5) or upper horizontal panels (13), the piece (1) also having an orifice (1.6) for attachment to the front sandwich panel (3).

The assembly procedure for the cabinet with retractable sliding doors is characterised in that it comprises the following stages:
Pre-assembling the left-hand side lateral assembly (11) and right-hand side lateral assembly (12), which consist of the union of the lateral sandwich panels (2, 3) to the upper and lower end pieces (1) that house the retractable doors (8). The pre-assembly consists of an in-factory assembly of the assembly described above, which also includes the retractable doors, and transporting assembled to its final location for the final assembly of the cabinet in its final location;
Joining the right-hand side lateral assembly (11) and left-hand side lateral assembly (12) to the upper panel (13) and lower panel (5);
Joining to the back panel (7).

The end pieces (1) are provided with at least one guide for housing the doors (8), end brackets (9, 10) for attachment to the lateral panels (2, 3), back panel (7) and lower (5) and upper (13) horizontal panels and longitudinal notches (4) in which the lateral panels (2, 3) are introduced, which are attached to the end piece (1) by screws.

Therefore, the end pieces (1) and the lateral panels (2, 3) are joined through the longitudinal notches (4) in which said panels (2, 3) are inserted, attached through orifices (16, 9.1.1, 10.1.1) made in the end pieces (1) and in the brackets (9, 10), subsequently inserting the retractable door (8) which slides in the guide of the end pieces (1) and is housed between the lateral panels (2, 3).

The right-hand side (11) and left-hand side (12) lateral assemblies and the upper (13) and lower (5) horizontal panels are joined through the orifices (10.2.1) made in the horizontal segments (10.2) of the brackets (10) of the end piece (1).

The back panel (7) is attached through orifices (9.1.1) of the vertical segment (9.1) of the bracket (9) of the end piece (1).

The essence of this invention is not affected by changes in the materials, shape, size and arrangement of the component elements, which are described in a non-limiting manner that allows its reproduction by an expert.

1. Cabinet with retractable sliding doors, among those which house the doors (8) between two lateral sandwich panels (2, 3), characterised in that it comprises a right-hand side assembly (11) and a left-hand side assembly (12) which consist of two lateral sandwich panels (2, 3) with upper and lower end pieces (1) that house the retractable doors (8), the cabinet also comprising a lower horizontal panel (5) and an upper horizontal panel (13) with guides (5.1) for opening and closing the doors (8) and a back panel (7) that closes the cabinet

2. Cabinet with retractable sliding doors according to claim 1, characterised in that the end pieces (1) comprise at least: a guide to house the doors (8); end brackets (9, 10) for attachment to the lateral panels (2, 3), back panel (7) and lower (5) and upper (13) horizontal panels; and longitudinal notches (4) in which the lateral panels (2, 3) are introduced, which are attached to the lateral piece (1) by screws.

3. Cabinet with retractable sliding doors according to claim 1, characterised in that the guide of the end pieces (1) has a first segment (1.1) placed in line with the guide (5.1) of the lower horizontal panel (5) or of the upper horizontal panel (13), followed by an elbow at approximately 90° and then an oblique segment (1.2) followed by a first segment (1.3) parallel to the cabinet sides (2, 3), and finally a U-elbow followed by a second segment (1.4) also parallel to the cabinet sides (2, 3).

4. Cabinet with retractable sliding doors according to claim 1, characterised in that the guide of the end piece (1) is provided along its entire length with a central protrusion (1.5) on its base for a correct displacement of the sliding door (8) that ends at an arrowhead (1.5.1) by which it is inserted in the guide (5.1) of the lower horizontal panel (5) or of the upper horizontal panel (13).

5. Cabinet with retractable sliding doors according to claim 1, characterised in that the rear bracket (9) is provided on its vertical segment (9.1) with two orifices (9.1.1) for attachment to the front sandwich panel (3) and the back panel (7), and on its horizontal segment (9.2) with another two orifices (9.2.1) for attachment to the lower horizontal panels (5) or upper horizontal panels (13), and in that the front bracket (10) is provided on its vertical segment (10.1) with two orifices (10.1.1) for attachment to the rear sandwich panel (7), while on its horizontal segment (10.2) it is provided with two orifices (10.2.1) for attachment to the lower horizontal panels (5) or upper horizontal panels (13), the piece (1) also having an orifice (1.6) for attachment to the front sandwich panel (3).

6. Assembly procedure for the cabinet with retractable sliding doors characterised in that it comprises the following stages:
Pre-assembling a left-hand side lateral assembly (11) and a right-hand side lateral assembly (12), which consist of the union of the lateral sandwich panels (2, 3) to the upper and lower end pieces (1) that house the retractable doors (8);
Joining the right-hand side lateral assembly (11) and left-hand side lateral assembly (12) to the upper panel (13) and lower panel (5);
Joining to the back panel (7).

7. Assembly procedure for the cabinet with retractable sliding doors according to claim 6, characterised in that the end pieces (1) are provided with at least: one guide for housing the doors (8); end brackets (9, 10) for attachment to the lateral panels (2, 3), back panel (7) and lower (5) and upper (13) horizontal panels; and longitudinal notches (4) in which the lateral panels (2, 3) are introduced, which are attached to the end piece (1) by screws.

8. Assembly procedure for the cabinet with retractable sliding doors according to claim 6, characterised in that the end pieces (1) and the lateral panels (2, 3) are joined through the longitudinal notches (4) in which said panels (2, 3) are inserted, attached through orifices (16, 9.1.1, 10.1.1) made in the end pieces (1) and in the brackets (9, 10), subsequently inserting the retractable door (8) which slides in the guide of the end pieces (1) and is housed between the lateral panels (2, 3).

9. Assembly procedure for the cabinet with retractable sliding doors according to claim 6, characterised in that the right-hand side (11) and left-hand side (12) lateral assemblies and the upper (13) and lower (5) horizontal panels are joined through the orifices (10.2.1) made in the horizontal segments (10.2) of the brackets (10) of the end piece (1).

10. Assembly procedure for the cabinet with retractable sliding doors according to claim 6, characterised in that the back panel (7) is attached through orifices (9.1.1) of the vertical segment (9.1) of the bracket (9) of the end piece (1).
